(19) United States
(12) Patent Application Publication
(10) Pub. No.: US 2007/0279303 A1
(43) Pub. Date: Dec. 6, 2007

(54) Antenna Structure for Series-Fed Planar Antenna Elements

(75) Inventor: Joerg Schoebel, Salzgitter (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/662,442

(22) PCT Filed: Aug. 1, 2005
(86) PCT No.: PCT/EP05/53734

§ 371 Date: Mar. 9, 2007

(30) Foreign Application Priority Data
Sep. 13, 2004 (DE) 10 2004 044 120.0

(51) Int. Cl. H01Q 1/32; H01Q 1/36

(52) U.S. Cl. 343/713; 343/700 MS

(57) ABSTRACT

In an antenna structure for series-fed, planar antenna elements, the spacing of the antenna elements to each other within a series-feed train is varied to influence the beam shaping.

### BACKGROUND INFORMATION

The present invention relates to an antenna structure for series-fed, planar antenna elements. Radar sensors which operate primarily in the 76-77 GHz frequency range are used in the field of driver-assistance functions having predictive sensing systems. For example, they are used for implementing the adaptive cruise control assistance function (ACC=adaptive cruise control) in the speed range of 50-180 km/h. Radar sensors of this type are also suitable in the lower speed range, e.g., for implementing an automatic traffic-jam following method, i.e., the functions “braking to a standstill” (without driving off again). Radar sensors are also advantageous for other convenience and safety functions such as monitoring the blind spot, backup aid and parking aid or pre-crash function (triggering of reversible restraint systems, priming of airbags, etc., preconditioning of the brake system, automatic emergency braking).

77-GHz radar sensors usually operate with lens antennas. Several partially overlapping radiation lobes are formed via a plurality of feed antennas located in the focal plane of the lens (“analog beam shaping”). FIG. 1 illustrates this principle. The azimuthal angle position of the target object is determined from the signal amplitudes and/or phases in the individual radiation lobes. Characteristic for lens antennas is the relatively large overall depth of several centimeters, which results due to the necessary distance of the feed antennas (in the focal plane) from the lens.

However, it is also possible to achieve an analog beam shaping with a planar design using planar antennas, so that the overall depth is considerably reduced. Suitable circuits for beam shaping such as Butler Matrix, Blass Matrix or planar lenses (Rotman lens) are known (DE 199 51 123 C2). A planar group antenna is used as antenna.

Other methods for signal evaluation, especially for determining the angle of the radar target, which do not require analog beam shaping are familiar, as well. The received signals are processed separately for each of the antenna elements and digitalized, and the beam shaping is implemented on the digital plane (“digital” beam shaping). Besides the digital beam shaping, in addition there are methods by which the azimuthal angle position of the target object can be determined, e.g., so-called high-resolution direction-estimating methods, beam-shaping thereby being dispensed with entirely.

One particularly simple and cost-effective design of a planar antenna is based on the series feed of the elements in one dimension of the antenna. The series feed in the antenna columns is especially relevant for motor-vehicle radar sensors. In this case, the columns are situated in the elevation direction of the radar sensor, thus vertically.

### SUMMARY OF THE INVENTION

Improved possibilities for beam shaping or side lobe attenuation may be attained using the measures in claim 1, i.e., influencing the beam shaping by varying the spacing of the antenna elements to each other within a series-feed train.

The use of the series feed in conjunction with the variation of the antenna-element spacing permits the configuration of a series-feed train as a column in a group antenna having a column spacing on the order of magnitude of half the free-space operating wavelength.

A deflection angle of the major lobe in elevation with respect to the antenna normal may be predefined, by which, for example, it is possible within certain limits to correct installation of a radar sensor on the motor vehicle at an angle.

Various possibilities for further influencing the beam shaping are delineated in the dependent claims. Further degrees of freedom are thereby yielded for optimizing a desired radiation, which advantageously are able to be combined with one another.

### BRIEF DESCRIPTION OF THE DRAWING

Exemplary embodiments of the present invention are elucidated in greater detail on the basis of the drawing, in which:

FIG. 2a shows a three-dimensional design of a group antenna;

FIG. 2b shows a planar design of an antenna with series feed;

FIG. 3a to d show various specific embodiments of conventional, planar, series-fed antenna columns;

FIG. 4a shows an antenna column with series feed and constant element spacing, and identical antenna radiator elements;

FIG. 4b shows an antenna column with series feed and constant element spacing, and variation of the antenna radiating elements;

FIG. 5a shows a series-fed antenna column according to the present invention with variable spacing of the antenna radiating elements;

FIG. 5b shows a series-fed antenna column according to the present invention with variable spacing of the antenna radiating elements and means for influencing phase between the antenna radiating elements;

FIG. 6a to d show examples for the phase influencing;

FIGS. 7a and b show further refinements with variations of the antenna radiating elements and the type of coupling;

FIG. 8a to d show modifications by varying the antenna radiating elements with respect to the width, i.e., the width of coupled stubs;

FIG. 9 shows further refinements by varying the coupling of the antenna radiating elements or the stubs.

### DESCRIPTION OF EXEMPLARY EMBODIMENTS

Before going into the actual invention, relevant, conventional antenna structures will first be explained for better understanding.

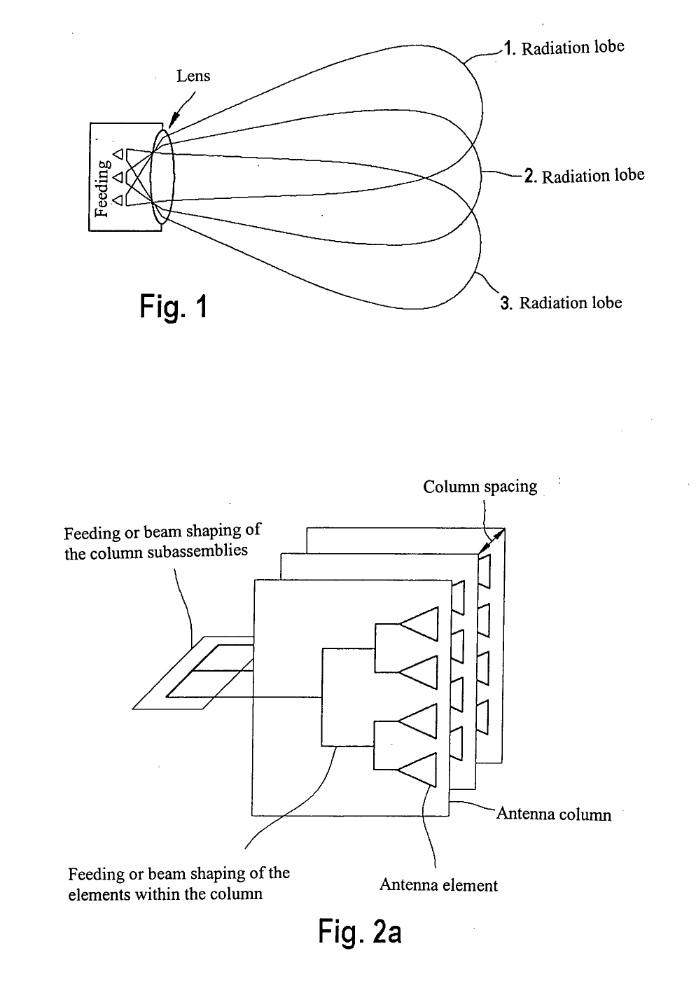

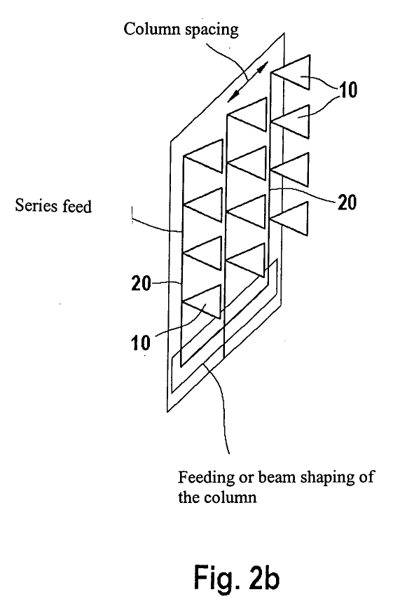

An antenna column having series feed is characterized in that a plurality of antenna radiating elements are coupled to a usually straight feeder line (FIG. 2b). At one end of an antenna column, an electromagnetic wave is applied to feeder line 20 (transmitting antenna) or tapped (receiving antenna). The elements are coupled in a manner that the antenna element radiates only a portion of the power of the electromagnetic wave incoming from the one side, or only a portion of the power available on the feeder line is coupled into the antenna element. The electromagnetic wave with the remaining power continues running on the feeder line to the other side of the antenna element. In addition, losses—primarily ohmic—occur on the feeder line and in the antenna elements. The end of the antenna column opposite the feed is usually either terminated anechoically or is provided with an antenna element which is designed in such a way that in transmit mode, it radiates all coupled-in power. In this case, one also speaks of a “traveling wave antenna” (leaky-wave antenna according to U.S. Pat. No. 4,063,245). If a standing wave forms on the antenna column, for example, because the end of the column is not anechoically terminated, e.g., with an open circuit or short circuit, then one speaks of a “standing wave antenna”. On such an antenna column, the elements are usually connected to the locations of the zero values of the current (current nodes) (U.S. Pat. No. 4,063,245).

In particular, patches, dipoles, slots or short line pieces (stub lines, “stubs”, see U.S. Pat. No. 4,063,245) are used as antenna elements. These elements may be grouped via connecting lines to form subgroups. To increase the bandwidth, a plurality of antenna radiating elements (patches) may be superposed in multilayer superstructures, so that they are electromagnetically coupled. For instance, the antenna elements may be coupled directly, capacitively or via stubs with slot coupling.

If antenna columns are to be placed side-by-side, e.g., in a 77 GHz radar sensor, so that “digital” beam shaping or “high-resolution” direction-estimating methods are possible using the signals of the antenna columns, then a spacing of the columns on the order of half the free-space wavelength of the radar signal, approximately 2 mm in the case of 77 GHz, is necessary. The same holds true for customary analog beam-shaping methods; in this case, however, a modification to larger column spacings is possible in principle within certain limits. If the quantity of antenna elements in a column exceeds a certain number—order of magnitude of 5—, for reasons of space in a planar design there is therefore no alternative to the series feed, even in the form of a feed from the center. In antenna systems for military or satellite applications, this restriction is usually circumvented by selecting a three-dimensional construction. Such a construction is sketched in FIG. 2a. The feed, or also, for example, control through analog beam shaping of the column, lies behind the elements, so that the subassemblies with the columns may be disposed side-by-side with close spacing. Such a configuration has to be ruled out for motor-vehicle radar sensors because of the high costs and the considerable size. FIG. 2b shows a planar design with series feed. The individual columns having antenna radiating elements 10 are fed from a signal source via a power splitter.

The major lobe of the radar antenna of a motor-vehicle radar sensor is dimensioned in elevation such that there is good detection of vehicles over the distance range covered by the sensor. If the operating range of the sensor is limited to only the far range, typical ACC, the major lobe may become relatively narrow in elevation. If the operating range of the sensor is also intended to extend into the close range, a wider major lobe may have to be provided in order to cover vehicles at their level. Ideally, the major lobe is dimensioned in such a way that unwanted reflections from the ground or from targets above the vehicles to be detected are avoided.

To further reduce the detection of unwanted radar targets (“clutter”), the radiation pattern of the radar antenna should be such that the side lobes are as small as possible in elevation. Clutter is produced, for example, by irradiation or detection of roughness or unevenness of the ground, manhole covers, foreign bodies, etc., as well as by detection of bridges, overhead signs, tunnel roofs, trees, etc.

The classic method for adjusting the side-lobe level is based on an amplitude distribution (taper) of the electromagnetic wave emitted by the individual elements, the amplitude distribution usually decreasing to the edges of the column. Suitable distribution functions, e.g., Tschebyscheff, Taylor, are found in the literature. In this context, a constant spacing of the elements of usually half the free-space wavelength and a constant phase difference of the antenna elements are assumed, i.e., in-phase state, if the radiation is intended to take place in the direction of the antenna normal. The width of the major lobe results from the selected amplitude distribution and the number of elements in the column.

This amplitude distribution may be implemented on one hand using a suitable power splitter, via which the generally identically constructed antenna elements are supplied; see feed within the columns of FIG. 2a. On the other hand, the antenna elements or their coupling to the feed—and therefore their radiation—may also be varied within the antenna. The first method is generally incompatible with a series feed for reasons of space. In principle, the latter method may also be employed when using a series feed.

However, depending upon the antenna element used, the latter method is encumbered with restrictions. When using a series-fed antenna column having directly coupled patch elements, the radiation of the elements can only be adjusted within certain limits. These limits are determined primarily by the maximum width of the antenna elements which, first of all, is determined by the electromagnetic coupling of the antenna columns, and secondly by the oscillation buildup of the first transversal mode in a patch element when the width of the patch attains the order of magnitude of the line wavelength.

The present invention describes an antenna structure for series-fed, planar antenna elements, particularly for a motor-vehicle radar system, in which the beam shaping is influenced by varying the spacing of the antenna elements to one another within a series-feed train. In this context, the antenna columns offer improved possibilities for beam shaping or side lobe attenuation compared to the related art.

The essence of the antenna structure according to the present invention is the arbitrary—thus non-equidistant—arrangement of the antenna elements in a series-feed train, that is, particularly on a series-fed antenna column in a motor-vehicle radar sensor in order to achieve a beam shaping or side lobe attenuation of the radiation lobe, emitted by the antenna, in the plane which is defined by the antenna normal and the antenna column. The antenna column is usually disposed in the direction of elevation, and the indicated plane is the elevation plane.

Advantageously, there are the following variations:
On average, the spacing of the antenna elements increases toward both edges of the column (thus not strictly monotonically from element to element—but averaged over several elements, the spacing becomes greater toward the edge; the minimum average spacing does not have to be exactly in the middle of the columns, but normally it will not be quite at the edge, either).
The spacing of at least two elements in one area of the column is smaller than half the free-space wavelength. This area is usually not situated at the edge of the column, but rather in the middle.
The spacing of at least two elements in the outer area of the column is markedly greater than half the free-space operating wavelength. The spacing may be on the order of one free-space wavelength and above.

This may be combined with the following options:
1. Adjusting the phase of the electromagnetic waves between two adjacent elements in the column. Two implementation possibilities are advantageous here:
   Use of a curved line between the elements,
   Use of a slow-wave structure or filter structure, made up of at least one line and at least one line piece that is connected to it and is terminated with an open circuit or short circuit, for adjusting the phase.
2. Variation of the antenna elements for adjusting the radiation of the individual elements within the limits predefined by the elements or the group antenna, e.g., altering the width of a patch element.
3. Modification of the coupling of the antenna elements to the feeder line for adjusting the radiation of the individual elements; e.g., different conductor widths or different transformers in the lead to the elements, different spacings in the case of capacitive coupling, different transformers/slots/stubs in the case of slot coupling, etc.

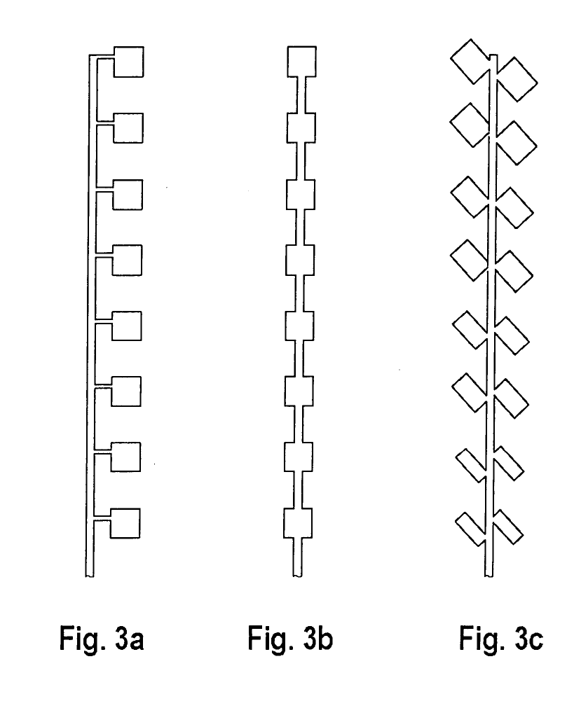

FIG. 3 shows schematic representations of series-fed antenna columns in motor-vehicle radar systems according to the related art:
a) the planar antenna possesses series-fed columns having identical patch elements coupled via lines, and constant spacing;
b) the planar antenna possesses series-fed columns having directly coupled, identical patch elements, and constant spacing;
c) the planar antenna possesses series-fed columns having directly coupled stub elements with variation of the stub dimensions, and constant spacing;
d) the planar antenna possesses series-fed columns having groups that are coupled via lines and are made up of directly coupled, identical patch elements, and constant spacing;
e) the planar antenna possesses series-fed columns having directly coupled patch elements with variation of the patch dimensions, and constant spacing.

All these antennas feature an approximately constant spacing of the elements. Possible slight variations of the element spacing are used for the exact adjustment of the in-phase emission of the elements, but not for producing a defined amplitude distribution per unit of length by varying the spacing.

To adjust the phase, in particular a curved line may be used between the elements of the antenna in order to proportionally reduce the spacing of the elements. Such configurations are found in the related art for controlling the angle of deflection of the radiation lobe using the operating frequency. Usually, in-phase elements specific to the electromagnetic wave on the feeder line are assumed. In this case, the point is to get the mechanical spacing of the elements small and the electrical spacing of the elements large, in order to attain a stronger frequency dependency of the deflection of the radiation lobe. On the other hand, in the present invention, the curved line is used to adjust the phase of the elements in view of a beam shaping or side lobe attenuation.

In this context, the phases of the antenna elements are not necessarily the same, but rather may be used for adjusting the radiation pattern (side lobe attenuation).

Planar antennas in motor-vehicle radar systems are usually constructed using microstrip line technology. A one-layer or multilayer microwave substrate is coated on both sides with metal. At least one of the two metal layers is structured and forms the signal-line plane. The feeder lines of the antenna columns, and possibly the transmit and receive modules or parts thereof are disposed in the signal-line plane. The other metallic plane forms the ground plane. Below the ground plane, further substrate and metallic planes may be disposed, in which, for example, the low-frequency/baseband and digital electronics for processing the low-frequency/baseband signals and for the control and possibly digital signal processing are constructed. In combination with this, still further microwave substrate planes may also be used, on which, for example, the transmit and receive modules may be mounted, if desired. Above the signal-line plane, further substrate and metallic planes may be located, on which, for instance, a plurality of antenna patches are superposed to increase the bandwidth, or planes having slot radiators or coupling slots and (slot-coupled) patches are located.

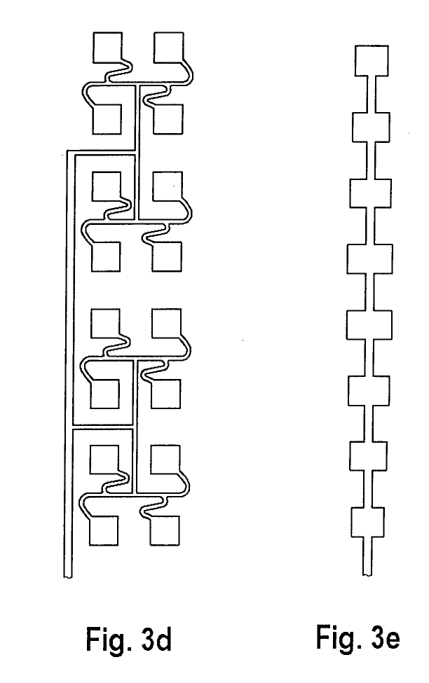

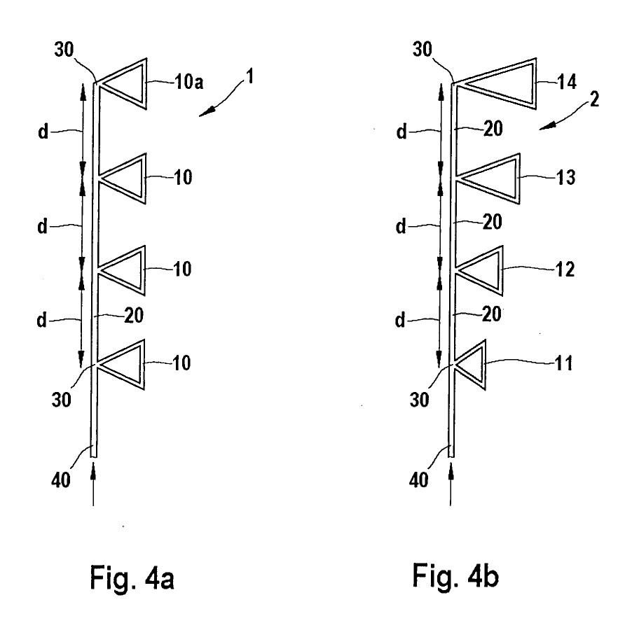

FIG. 4a show schematically the structure of an antenna column 1 having series feed (FIG. 3a, b, d). Feeder lines 20 of the antenna columns are situated in the indicated signal-line plane. They are usually implemented as microstrip lines, in doing which, a plurality of sections having different impedances for the impedance matching may occur.

Antenna elements 10 are coupled to feeder line 20. In the simplest case, this may be implemented by direct coupling 30 in series connection to the feeder line (see FIG. 3b, e) or, e.g., via leads (see FIG. 3a, d) or via capacitive coupling. Further possibilities are the coupling of the radiator element via the electromagnetic field in the form of slot coupling, or the slots are used directly as radiators.

Patches (see FIG. 3a, b, e), stub lines/stubs (see 3c), dipoles, slots or groups of individual elements (see FIG. 3d) are used, for example, as antenna elements. At the end of a column, one element 10a may be used which radiates all incoming power, so that no reflection occurs.

Characteristic for series-fed antenna column 1 is that the available power decreases continually from infeed 40 to the end of the column. Each element radiates a fraction of the power available at the location of the element, or at the location of the coupling of the element. In addition, losses—primarily ohmic losses—occur in the elements and on the feeder line between the elements. When all elements 10, spacings d of the elements and feeder line 20 between the elements are the same, then the power distribution is dropping approximately exponentially from the feed to the end of the column, element 10a at the end of the column being able to radiate a power falling off from this characteristic.

This power distribution determines the beam shape of the radiation lobe produced by the column, the side lobe attenuation usually being poorer than 14 dB (13.6 dB are achieved, given a uniform distribution of the power). As a rule, this value is not adequate for applications in motor-vehicle radar systems.

Good side lobe attenuation is supplied primarily by power distributions which have a maximum in the middle of the antenna column and decrease continually toward the edges. Such functions assume a constant spacing of the antenna elements.

To achieve such a power distribution in a series-fed column, according to the related art, elements 11, 12, 13, 14 are modified as a function of their position on the column in order to alter the fraction of the available power which an element radiates, and thereby to improve the power distribution. Such a column 2 is sketched in FIG. 4b (compare FIG. 3c, e).

Within the scope of this invention, the beam shaping on the antenna column now is not (or is not only) achieved by modification of the elements, but (or but also) by variation of spacing dᵢ of the elements on the column.

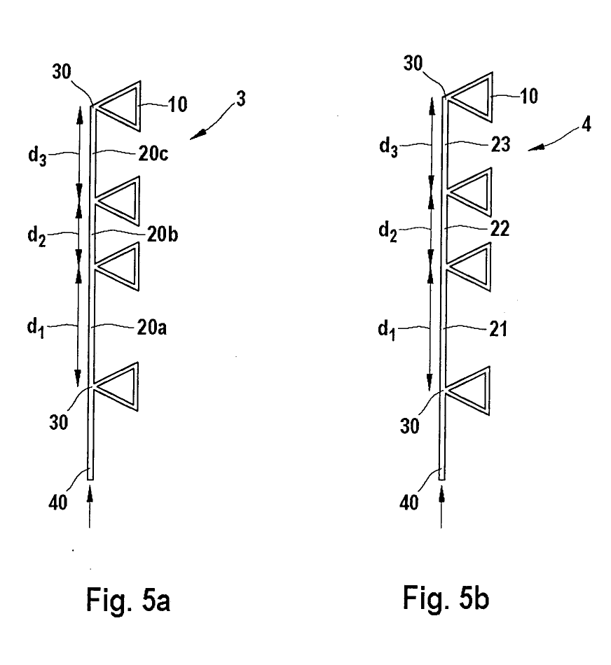

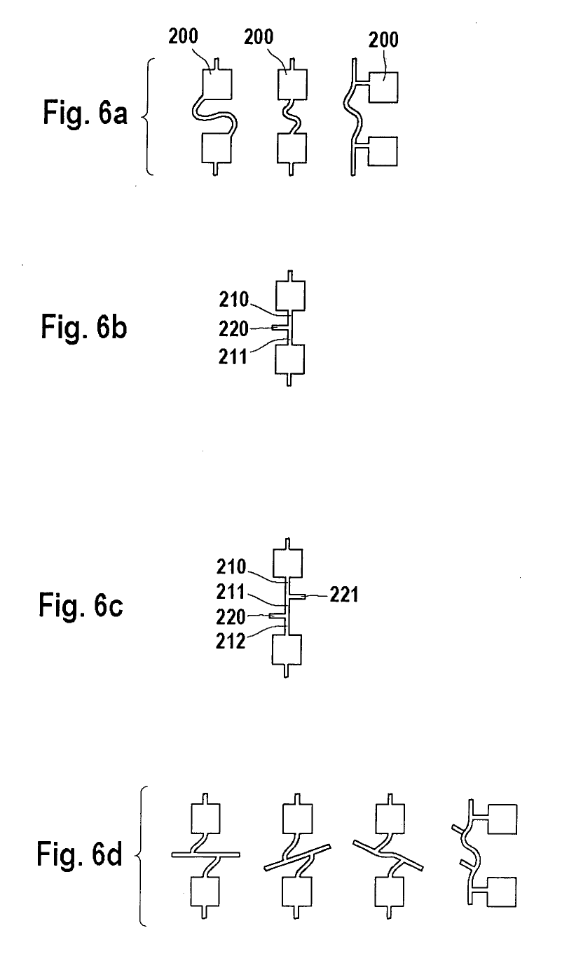

In this context, it is possible to increase the power radiated per unit of length in a middle region of the column in particular, by selecting an element spacing to be smaller than half the free-space wavelength. At the edge of the column, an element spacing may occur which is markedly greater than half the free-space wavelength, e.g., on the order of one free-space wavelength and more, in order to reduce the power radiated per unit of length accordingly. FIG. 5a shows such a column 3 schematically. At least one of the spacings d₁, d₂, d₃ of the antenna elements differs from the others. The sections of feeder line 20a, 20b, 20c between the elements are identical except for their lengths. Lines 20a, 20b, 20c may also be made up of a plurality of sections having different width or impedance.

No further general rules may be established for the placement and possible modification of the elements or their radiation or of the coupling, since the phase of the elements and the resulting power distribution on the column must be taken into account.

Therefore, methods such as iterative algorithms or non-linear multidimensional optimization methods or “genetic” algorithms must be utilized for determining the placement. Parameters of the optimization method are the locations of the elements and possibly their radiation efficiency, which results from the modification of the elements (e.g., width in the case of patch elements or stubs). The available power and the phase at the elements may be calculated from suitable models for the feeder line and for the radiators. From the positions, excitation energy and phases of the elements, it is possible to calculate the radiated power as a function of the elevation angle. As a target function of the optimization, for example, a function for the radiation amplitude is predefined as a function of the elevation angle, or a value for the side lobe attenuation is predefined as a function of the elevation angle. The method evaluates the calculated radiation of the antenna column from a comparison with the target function and corrects the parameters in a suitable manner. In this context, the correction depends in particular upon the method selected. The calculation is carried out anew with the corrected parameters until the evaluation satisfies a predefined target.

A further refinement of the present invention is to adjust the phase of the electromagnetic wave between two adjacent elements in the column. Consequently, through the optimization method described above, the phase at the elements no longer results from the length of feeder lines 20a, 20b, 20c between the elements, but rather may be selectively influenced. This improves the beam shaping, especially in view of the narrowest possible major lobe, and permits asymmetrical characteristics, e.g., with very low side lobes on one side of the major lobe (reduction of ground clutter in motor-vehicle radar sensors). FIG. 5b shows such a column 4 schematically. At least one of the spacings d₁, d₂, d₃ of the antenna elements differs from the others. The sections of feeder line 21, 22, 23 between the elements are used for targeted influencing of the phase at the elements.

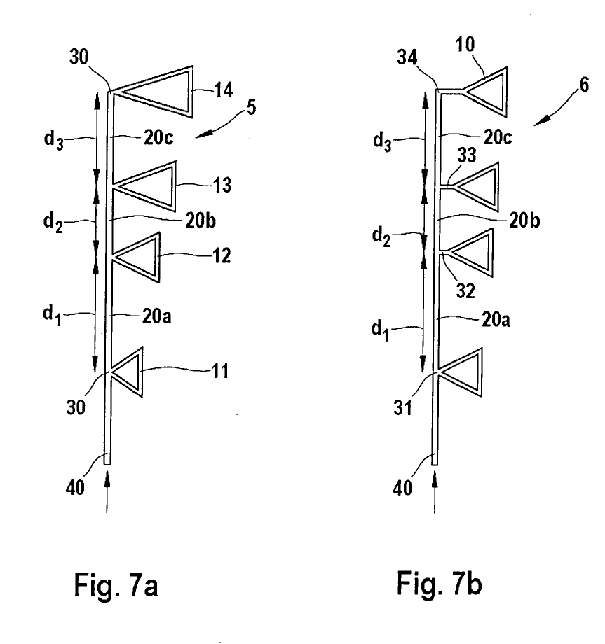

Two implementation possibilities are particularly advantageous for this purpose:
Use of a curved line 200 between the elements. Using the curved line (e.g., S-shaped), it is possible to increase the phase difference between two directly coupled elements compared to the direct straight connection (FIG. 6a).
Use of a slow-wave structure or filter structure for adjusting the phase. This structure is made up of at least one (also curved) line 210, 211, 212, and at least one line piece 220, 221 (also curved or “radial stub”, etc.) connected to it, that is terminated with an open circuit or short circuit. With such a structure, it is possible to almost arbitrarily adjust the phase except for multiples of 360°, the structure being matched on both sides. FIG. 6 shows examples for specific embodiments of the structure: b), one stub with lines; c), two stubs with lines; d), variants of c by the example of directly fed patch elements.

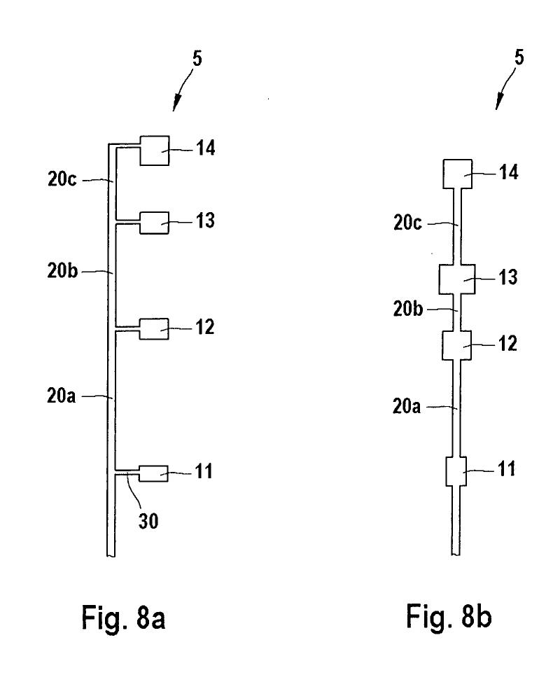

Additionally, in another further refinement, modifications of the elements are also used for beam shaping. Directly fed patch elements and stub elements are usually dimensioned in such a way that the electromagnetic wave in the longitudinal direction of the elements develops a resonance. The emission may be adjusted within certain limits by the width of the elements (compare FIG. 3c, e). The beam shaping/side lobe attenuation is thereby improved. FIG. 7a shows the principle of this further refinement in an antenna column 5. At least one of the elements 11, 12, 13 is constructed differently from the other elements 11, 12, 13 in order to influence the emission. In any case, end element 14 may differ from the elements of the column. It may be included in the optimization of the radiation pattern, as well.

In another refinement, the emission of the elements is adjusted via the coupling to the feeder line, in order to improve the beam shaping/side lobe attenuation. If the elements are coupled via lines, this may be achieved by varying the impedance ratios of, the feeder line and the coupling line. In the case of a capacitive coupling of the elements, the coupling may be influenced by the distance of the elements from the feed. FIG. 7b shows the principle of this further refinement in an antenna column 6. At least one of the couplings 31, 32, 33, 34 is constructed differently from the other couplings, in order to influence the power supply into the corresponding element, and therefore the emission of this element.

The aforesaid further refinements may advantageously be combined with one another.

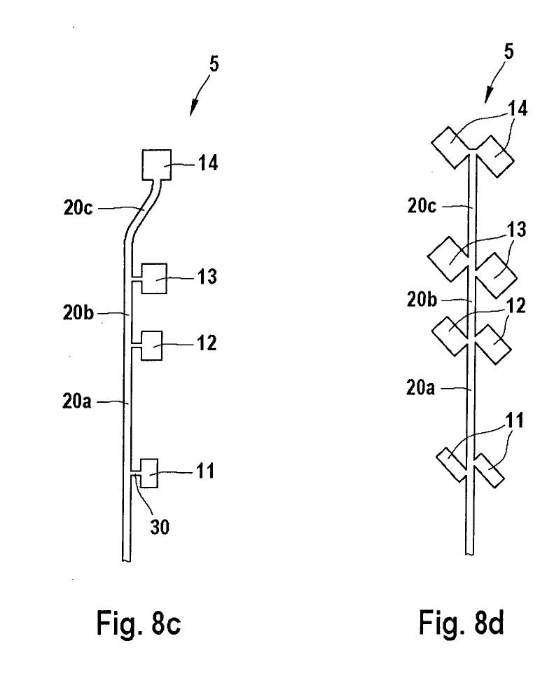

FIG. 8 shows several implementation possibilities for the variation of the elements in column 5.

FIGS. 8a, b and c show the modification of the width of patch elements, the coupling being accomplished via lines, directly or capacitively. Further possibilities are, for example, to vary the width of slot-coupled patches, or to vary the dimensions of slot radiators or dipole radiators.

FIG. 8d shows the modification of the width of directly coupled stubs.

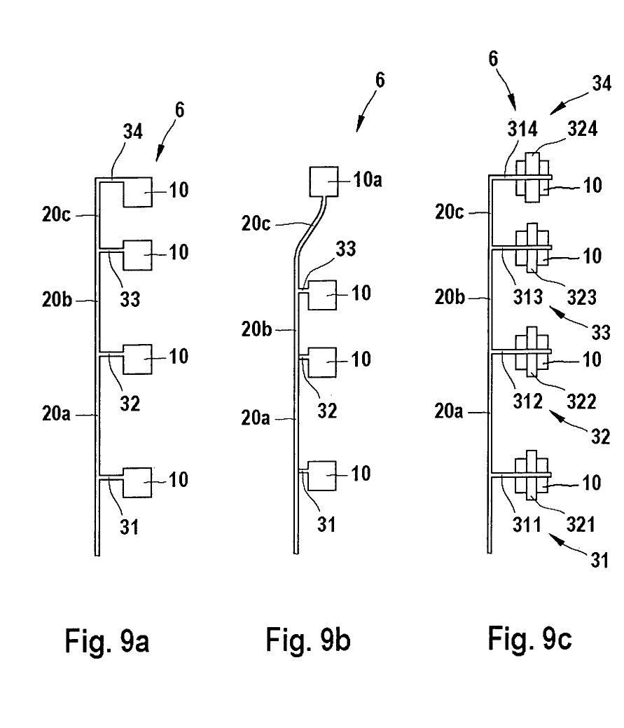

FIG. 9 shows implementation possibilities for varying the coupling:
a) Modification of the width/impedance of the lines for coupling the patches, and variation of the coupling point to the patch;
b) Modification of the distance of a capacitively coupled patch from the feeder line;
c) Modification of the width/impedance/length of the stubs and the measurements/positions of the coupling slots when using slot coupling. Slot coupling 31, 32, 33, 34 is made up of stubs 311, 312, 313, 314, slots 321, 322, 323, 324 in the ground metallization and patch elements 10 in a further metallic plane, which is located on the side of the ground metallization opposite the signal-line plane.

Until now, the antenna structure of the present invention was explained in light of columns as series trains. Naturally, the feeder line may also be used for antenna rows. The aforesaid exemplary embodiments must then be modified accordingly. The aforementioned antenna structures may be used for transmitting antennas as well as for receive antennas or combinations thereof.

1-9. (canceled)

10. An antenna structure comprising:
series-fed, planar antenna elements; and
an influencing arrangement to influence beam shaping by varying spacing of the antenna elements to each other within a series-feed train.

11. The antenna structure of claim 10, wherein between at least two adjacent antenna elements, there is an arrangement to influence a phase between the at least two adjacent antenna elements.

12. The antenna structure of claim 10, wherein the spacing of at least two of the antenna elements increases starting from approximately a middle of a series-feed train toward edge areas.

13. The antenna structure of claim 10, wherein the spacing of at least two of the antenna elements within a series-feed train is selected to be smaller than half of a free-space operating wavelength.

14. The antenna structure of claim 12, wherein in the edge areas of the series-feed train, the spacing of the at least two antenna elements is selected to be substantially greater than half of the free-space operating wavelength, which is in a range of at least the free-space operating wavelength.

15. The antenna structure of claim 11, wherein a curved line influences the phase.

16. The antenna structure of claim 11, wherein one of a slow-wave structure and a filter structure, the structure having at least one stub line, influences the phase.

17. The antenna structure of claim 10, wherein a coupling of the antenna elements to the series-feed train is variably selected to further influence the beam shaping.

18. The antenna structure of claim 10, wherein a width of the antenna elements within the series-feed train is variably selected.

19. The antenna structure of claim 10, wherein the series-fed, planar antenna elements are for a motor-vehicle radar system.
